(19) United States
(12) Patent Application Publication
(10) Pub. No.: US 2008/0109773 A1
(43) Pub. Date: May 8, 2008

(54) Analyzing Impedance Discontinuities In A Printed Circuit Board

(76) Inventor: Daniel Douriet, Round Rock, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/555,750

(22) Filed: Nov. 2, 2006

(51) Int. Cl. G06F 17/50

(52) U.S. Cl. 716/5

(57) ABSTRACT

Analyzing impedance discontinuities in a printed circuit board, where the printed circuit board is made up of layers of dielectric substrate having signal traces and power planes disposed upon the layers of substrate, the signal traces include trace segments, and the printed circuit board described by a computer-aided design (‘CAD’), including creating, by an impedance discontinuity analysis module from the CAD, a geometric description of each power plane, including representing each geometric description of each power plane as a set of non-overlapping rectangles; creating a geometric description of each signal trace, including projecting the signal traces of one side of a layer of dielectric substrate onto at least one signal plane on the other side of the same layer of substrate; and identifying at least one impedance discontinuity of a signal trace in dependence upon the geometric description of each signal trace and the geometric description of each power plane.

### BACKGROUND OF THE INVENTION

1 Field of the Invention

The field of the invention is data processing, or, more specifically, methods, systems, and products for analyzing impedance discontinuities in a printed circuit board.

2. Description Of Related Art

In current organic carrier and printed circuit board designs, the power plane structures and geometries are very complex. The occurrence of multiple voltage domains with multiple voltage plane voids and gaps makes it extremely difficult to verify that all critical high speed signals have an adequate transmission line geometry and that any impedance discontinuity present is identified and quantified. Of special importance is the identification of signal traces with reference plane discontinuities, such as signal traces going over plane openings, traces crossing across plane gaps, and traces being referenced by the wrong voltage plane.

The performance of high end servers is in direct correlation to how fast their signal buses are able to run. As the clock frequencies increase and logic voltage levels are reduced, the noise margins for high speed signals are reduced. In addition, higher switching frequencies imply that discontinuities of signal traces become geometrically smaller when compared with said signal's total lengths. High speed signals are treated as transmission lines. The quality of a high speed signal is dependent on how well implemented as transmission lines are the several trace segments of the signal. Reference plane discontinuities, when large as compared with the electrical length of the signal frequencies, are a major contributor to the degradation of the signal quality. Therefore, it is important to have the means to verify that a given design is free of such impedance discontinuities.

Current verification practices involve visual inspection, which is not practical, reliable or time efficient. Electrical modeling is not feasible, because in order to work, the whole packaging structure would have to be modeled, which would be time consuming and expensive. Attempts to process the voltage plane geometries using a computer program are not straightforward, specially with organic carrier designs, as the signal reference structures are made up of overlapping polygons, voids, and traces. In order to resolve all overlaps and edge intersections between traces and reference structures requires a complex set of geometric algorithms and the consideration of multiple structures and special cases. There is an ongoing need, therefore, for improvement in the area of analyzing impedance discontinuities in printed circuit boards.

### SUMMARY OF THE INVENTION

Methods, apparatus, and computer program products are disclosed for analyzing impedance discontinuities in a printed circuit board, where the printed circuit board is made up of layers of dielectric substrate having signal traces and power planes disposed upon the layers of dielectric substrate, the signal traces include trace segments, and the printed circuit board described by a computer-aided design (‘CAD’). Embodiments include creating, by an impedance discontinuity analysis module from the CAD, a geometric description of each power plane, including representing each geometric description of each power plane as a set of non-overlapping rectangles. Embodiments also include creating, by the impedance discontinuity analysis module from the CAD, a geometric description of each signal trace, including projecting the signal traces of one side of a layer of dielectric substrate onto at least one signal plane on the other side of the same layer of dielectric substrate. Embodiments also include identifying by the impedance discontinuity analysis module at least one impedance discontinuity of a signal trace in dependence upon the geometric description of each signal trace and the geometric description of each power plane.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram illustrating an exemplary apparatus for analyzing impedance discontinuities in a printed circuit board according to embodiments of the present invention.

FIG. 2 sets forth a block diagram of automated computing machinery comprising an exemplary computer useful in analyzing impedance discontinuities in a printed circuit board according to embodiments of the present invention.

FIG. 3 sets forth a cross-section view of an example printed circuit board useful in analyzing impedance discontinuities in a printed circuit board according to embodiments of the present application.

FIG. 4 illustrates a two-dimensional projection of several signal traces from one side of a layer of dielectric substrate onto two power planes from the other side of the same layer of dielectric substrate.

FIG. 5 illustrates a two-dimensional projection of a signal trace from one side of a layer of dielectric substrate onto a power plane from the other side of the same layer of dielectric substrate.

FIG. 6 sets forth an entity relationship diagram illustrating an exemplary data model useful for analyzing impedance discontinuities in a printed circuit board according to embodiments of the present invention.

FIG. 7 sets forth a flow chart illustrating an exemplary method for analyzing impedance discontinuities in a printed circuit board according to embodiments of the present invention.

FIG. 8 sets forth a flow chart illustrating a further exemplary method for analyzing impedance discontinuities in a printed circuit board according to embodiments of the present invention.

FIG. 9 sets forth a flow chart illustrating a further exemplary method for analyzing impedance discontinuities in a printed circuit board according to embodiments of the present invention.

FIG. 10 sets forth a flow chart illustrating a further exemplary method for analyzing impedance discontinuities in a printed circuit board according to embodiments of the present invention.

### DETAILED DESCRIPTION OF EXEMPLARY EMBODIMENTS

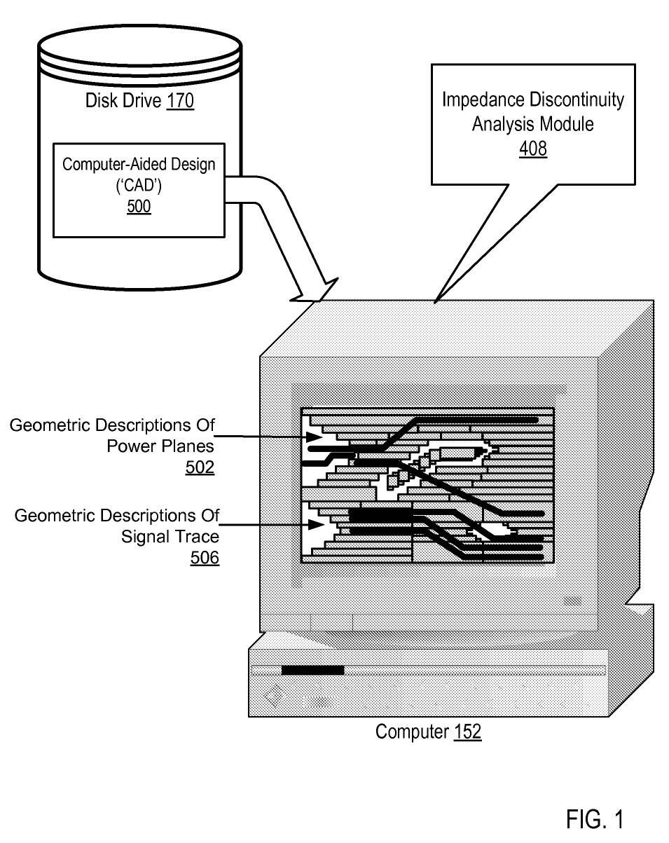

Exemplary methods, systems, and products for analyzing impedance discontinuities in a printed circuit board according to embodiments of the present invention are described with reference to the accompanying drawings, beginning with FIG. 1. FIG. 1 sets forth a functional block diagram illustrating an exemplary apparatus for analyzing impedance discontinuities in a printed circuit board according to embodiments of the present invention. The apparatus of FIG. 1 include a computer (152) that is operatively coupled to a disk drive (170) upon which is stored a computer-aided design (‘CAD’) (500) of a printed circuit board. The computer (152) has installed within it an impedence discontinuity analysis module (408), which is an application-level module of computer program instructions for analyzing impedance discontinuities in a printed circuit board according to embodiments of the present invention.

In this example, the impedence discontinuity analysis module (408) includes computer program instructions that cause the computer to function generally to analyze impedance discontinuities in a printed circuit board according to embodiments of the present invention as follows. A printed circuit board is composed of layers of dielectric substrate having signal traces and power planes disposed between the layers of dielectric substrate. The signal traces are made up of trace segments, and the printed circuit board is described by a CAD (500). The impedence discontinuity analysis module creates from the CAD (500) a geometric description of each power plane, including representing each geometric description of each power plane as a set of non-overlapping rectangles (502). The impedence discontinuity analysis module also creates from the CAD a geometric description of each signal trace, including projecting the signal traces of one side of a layer of dielectric substrate onto at least one signal plane on the other side of the same layer of dielectric substrate (506). The impedence discontinuity analysis module also identifies at least one impedance discontinuity of a signal trace in dependence upon the geometric description of each signal trace and the geometric description of each power plane.

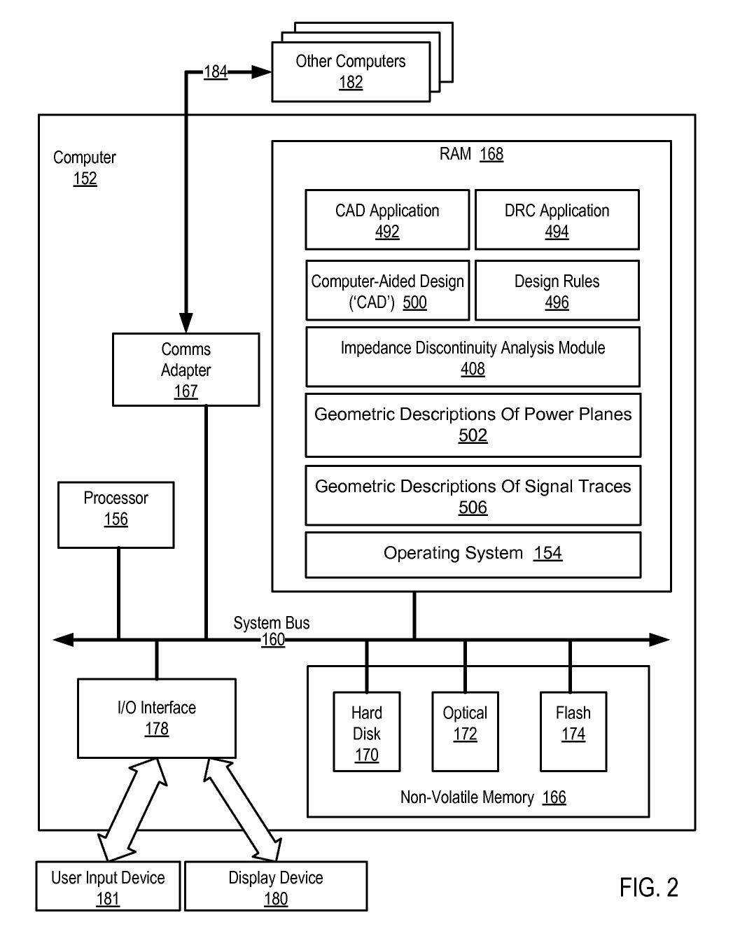

Analyzing impedance discontinuities in a printed circuit board in accordance with the present invention is generally implemented with computers, that is, with automated computing machinery. For further explanation, therefore, FIG. 2 sets forth a block diagram of automated computing machinery comprising an exemplary computer (152) useful in analyzing impedance discontinuities in a printed circuit board according to embodiments of the present invention. The computer (152) of FIG. 2 includes at least one computer processor (156) or ‘CPU’ as well as random access memory (168) (“RAM”) which is connected through a system bus (160) to processor (156) and to other components of the computer.

Stored in RAM (168) is a CAD (computer-aided design) application program (492). Computer-aided design is the use of a wide range of computer-based tools that assist engineers, architects and other design professionals in their design activities. It is the main geometry authoring tool within the overall process of electronic product lifecycle management and involves both software and sometimes special-purpose hardware. Current packages range from 2D vector based drafting systems to 3D parametric surface and solid design modellers.

‘CAD’ is sometimes translated as “computer-assisted”, “computer-aided drafting”, or a similar phrase. A CAD application is a tool for designing and producing electronic systems ranging from printed circuit boards to integrated circuits. Examples of CAD applications useful for analyzing impedance discontinuities in a printed circuit board in accordance with the present invention include the Allegro™ application from Cadence Design Systems, the PADS application from Mentor Graphics, as well as CAD applications from Synopsys, Inc., Magma Design Automation, Inc., Zuken, Inc., as well as other that may occur to those of skill in the art. CAD tools and applications are sometimes referred to as ‘CADD’ which stands for Computer-Aided Design and Drafting, ‘CAID’ for Computer-Aided Industrial Design, ‘CAAD’ for Computer-Aided Architectural Design, ‘EDA’ for Electronic Design Automation, ‘ECAD’ for Electronic Computer-Aided Design, and ‘CAE’ for Computer-Aided Engineering. All these terms are essentially synonymous, and no doubt there are other terms as will occur to those of skill in the art that are more or less synonyms for CAD. For clarity of reference in this specification, however, computer-aided design application programs and modules are referred to as ‘CAD applications,’ and the output of such CAD applications, that is a computer-aided design file as such, is referred to as a ‘computer-aided design’ or a ‘CAD.’

Also stored in RAM in this example is a computer-aided design, the CAD (500). The CAD (500) is an aggregation of computer data that describes a printed circuit board, including the physical structure of the printed circuit board as well as the layout of power planes and signal traces on or between the layers of the printed circuit board. A CAD may be expressed in the GDSII stream format, commonly known as GDSII, a well-known file or database format for IC and printed circuit board layout data exchange, proprietary to Cadence Design Systems. GDSII is a binary format for representation of planar geometric shapes, text labels, and other information in hierarchical form. The objects are grouped by numeric attributes assigned to them, layer numbers, object type codes, and so on, including descriptions of the physical layout of a circuit or printed circuit board being designed. Alternatively, a CAD may be expressed in the OASIS™ format. ‘OASIS’ stands for Open Artwork System Interchange Standard, a specification for hierarchical integrated circuit mask layout data format for interchange between EDA software, IC mask writing tools and mask inspection tools. The name OASIS is a trademark of the Semiconductor Equipment and Materials Institute (‘SEMI’). OASIS was developed through SEMI by a consortium of CAD industry companies. Like GDSII, OASIS is a binary data format. GDSII and OASIS are mentioned here only as examples for explanation of CAD, not for limitation of the invention. A CAD that is useful for analyzing impedance discontinuities in a printed circuit board according to embodiments of the present invention may be expressed in any format that may occur to those of skill in the art.

Also stored in RAM in this example is a design rules checking (‘DRC’) application (494). A DRC application is a CAD tool that determines whether a particular printed circuit board design satisfies a series of recommended parameters called ‘design rules.’ Design rules (496) are a series of parameters that enable the designer to verify the correctness of the layout of power planes and signal traces on layers of a printed circuit board. A design rule set specifies certain geometric and connectivity restrictions to ensure sufficient margins to account for variability in manufacturing processes. A DRC application usually takes as input a CAD in, for example, the GDSII format or the OASIS format, and produces a report of design rule violations that the designer may or may not choose to correct. The designer may, for example, carefully “stretch” or waive certain design rules to increase performance and component density at the expense of yield. Most DRC products define some language to describe the operations and the design rules needed to be performed in DRC. Mentor Graphics' DRC application, for example, uses the Standard Verification Rule Format (‘SVRF’) language to express sets of design rules. The usefulness of a DRC application in analyzing impedance discontinuities in a printed circuit board in accordance with the present invention is that an identified impedence discontinuity may be reported to a designer as design rule violation from a DRC application - a rule violation which the designer may or may not correct in the CAD according to the severity of the impedance discontinuity.

Also stored in RAM (168) is an impedance discontinuity analysis module (408), which is a module of application-level computer program instructions capable of causing a computer to analyze impedance discontinuities in a printed circuit board in accordance with the present invention by creating from the CAD (500) a geometric description (502) of each power plane, including representing each geometric description of each power plane as a set of non-overlapping rectangles; creating from the CAD a geometric description (506) of each signal trace, including projecting the signal traces of one side of a layer of dielectric substrate onto at least one signal plane on the other side of the same layer of dielectric substrate; and identifying at least one impedance discontinuity of a signal trace in dependence upon the geometric description of each signal trace and the geometric description of each power plane. The impedance discontinuity analysis module can be implemented to use design rule violations of the kind generated by the DRC application (494) to advise a designer of identified impedence discontinuities, and it is therefore entirely within the scope of the present invention to improve the DRC application to include the functions of the impedance discontinuity analysis module. For ease of explanation, however, exemplary embodiments of the invention in this specification are described with reference to a separate impedence discontinuity analysis module (408).

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. In this example, the operating system (154) as well as the CAD application (492), the DRC application (494), the CAD (500), the design rules (496), the impedance discontinuity analysis module (408), the geometric descriptions of power planes (408), and the geometric descriptions of signal traces (506) all are shown in RAM (168), but many components of such software typically are stored also in non-volatile memory (166).

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for analyzing impedance discontinuities in a printed circuit board according to embodiments of the present invention include modems for wired dial-up communications, Ethernet (IEEE 802.3) adapters for wired network communications, and 802.11b adapters for wireless network communications.

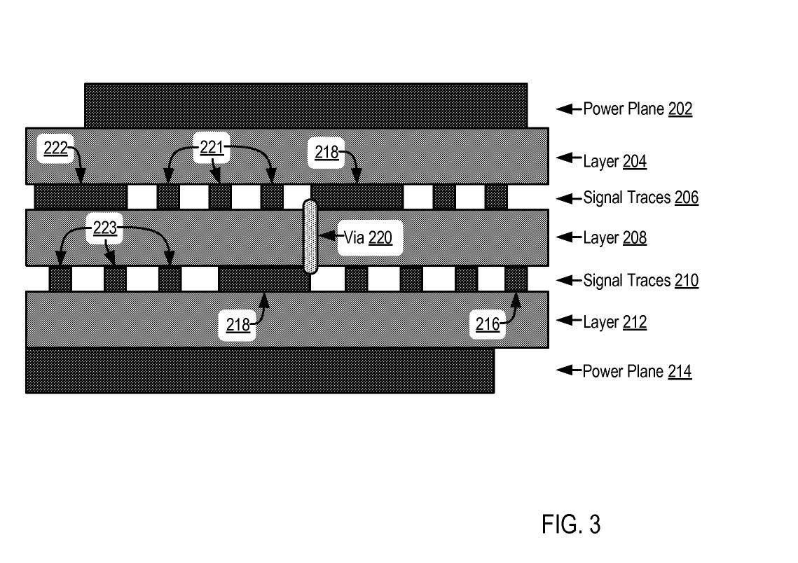

For further explanation, FIG. 3 sets forth a cross-section view of an example printed circuit board useful in analyzing impedance discontinuities in a printed circuit board according to embodiments of the present application. The printed circuit board of FIG. 3 includes three layers (204, 208, 212) of dielectric substrate with signal traces (206, 210) disposed between the layers and power planes (202, 214) on the outside surfaces. A printed circuit board is used to mechanically support and electrically connect electronic components using conductive pathways, or signal traces and power planes, etched from copper sheets laminated onto a non-conductive or dielectric substrate. Most printed circuit boards are composed of between one and sixteen conductive layers separated and supported by layers of dielectric material, called ‘substrates,’ laminated together, that is, glued with heat, pressure, and sometimes vacuum. Layers may be connected together through drilled holes called ‘vias.’ Either the holes are electroplated or small rivets are inserted. High-density printed circuit boards may have blind vias, which are visible only on one surface, or buried vias, which are visible on neither. Some dielectric substrates are made of paper impregnated with phenolic resin. Other dielectric substrates are made of a woven fiberglass mat impregnated with a flame resistant epoxy resin. The term ‘printed circuit board’ as used here includes not only the larger printed circuit boards typically used as backplanes or motherboards in computers and other electronic devices, but also includes the (typically smaller) printed circuit boards used as first-level chip carriers for mounting integrated circuits onto larger backplanes or motherboards. The dielectric substrates are ‘dialectric’ in that they do not conduct electric current but they do conduct electric fields. Thus a dielectric layer between a high speed signal on a signal trace and a power plane forms a transmission line for the high speed signal, where the transmission line so formed has a characteristic impedence. For signal traces that maintain the characteristic impedance, signal transmissions among devices coupled through the traces is efficient and reliable. Physical defects in a signal trace or in the signal trace's relationship to a power plane create ‘impedance discontinuities’ that reflect a portion of the signal. The reflected portion of the signal is an undesired signal, that is, noise. As noise on a signal trace increases, power efficiency and reliability both decrease. A power plane is said to ‘cover’ a signal trace on the opposite side of the same layer of dielectric substrate if a two-dimensional projection of the signal trace onto the power plane lies entirely upon the power plane.

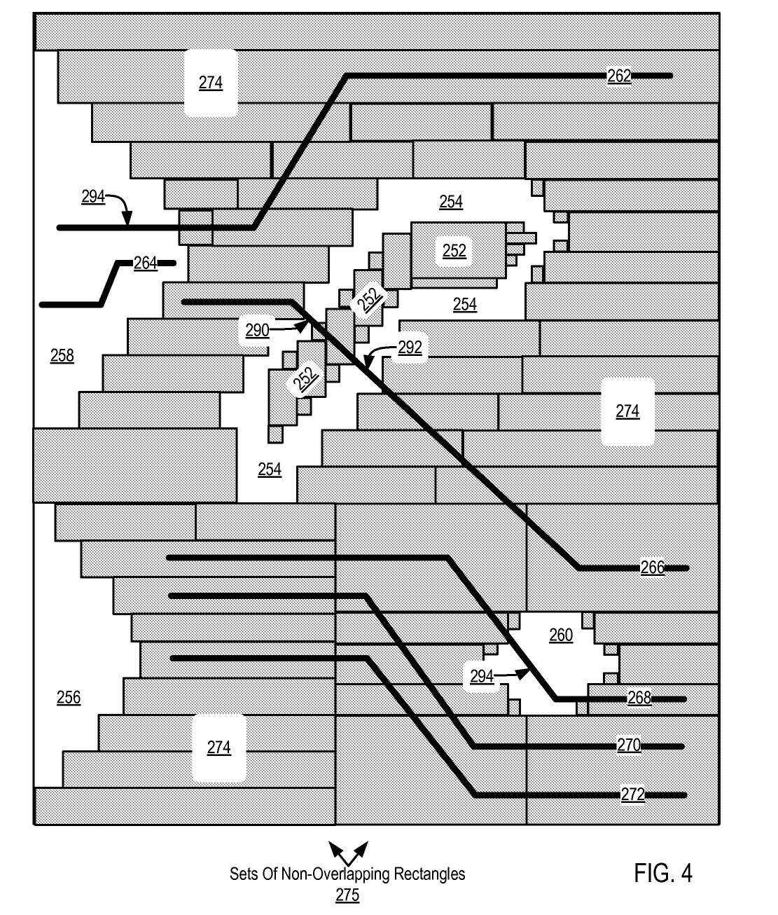

Physical defects that represent or cause impedance discontinuities include a signal trace partially or entirely not covered by a power plane and a signal trace covered by a power plane of a voltage on one layer of the printed circuit board where the signal trace changes levels through a via to be covered in another layer by a power plane of another voltage. In the example of FIG. 2, the three signal traces (221) are depicted as covered by power plane (202), thus showing no apparent impedence discontinuity. Similarly, the three signal traces (223) are depicted as covered by power plane (214), thus showing no apparent impedence discontinuity. Signal trace (222), however, represents an impedance discontinuity because signal trace (222) is only partially covered by power plane (202). In addition, if power plane (202) is a three volt power plane and power plane (214) is a five-volt power plane, then signal trace (218) presents an impedence discontinuity where the signal trace (218) passes through the via (220) from one side to the other side of the dielectric substrate layer (208). For further explanation, FIG. 4 illustrates a two-dimensional projection of several signal traces (262, 264, 266, 268, 270, 272) from one side of a layer of dielectric substrate onto two power planes (252, 274) from the other side of the same layer of dielectric substrate. FIG. 4 depicts a geometric description of each power plane (252, 274), where the geometric descriptions are created by an impedance discontinuity analysis module from a CAD, and each geometric description of each power plane is represented as a set of non-overlapping rectangles (275).

The projection of FIG. 4 shows that the entirety of signal trace (264) is not covered by any power plane, so that all of signal trace (264) represents an impedance discontintuity. Signal traces (270, 272) are entirely covered by power plane (274) and therefore represent no impedance discontinuity.

A ‘void’ is a hole in coverage of a power plane. Such a hole might be left when the power plane was designed to allow a signal trace on the power plane side of the substrate or to accommodate a via, for example. Power plane (274) defines three voids (256, 258, 260) in its coverage, and signal trace (268) presents an impedance discontinuity (294) where the signal trace (268) crosses one of the voids (260). Similarly, the portion (294) of signal trace (262) that lies uncovered on void (258) represents an impedance discontinuity.

A ‘gap’ is an absence of power plan coverage between two power planes disposed on the same side of a layer of dielectric substrate. In this example, power planes (252, 274) are both disposed on the same side of the same layer, and there is a gap (254) in coverage between the two power planes. Signal trace (266) presents two impedance discontinuities (290, 292) where the signal trace (266) twice crosses the gap (254).

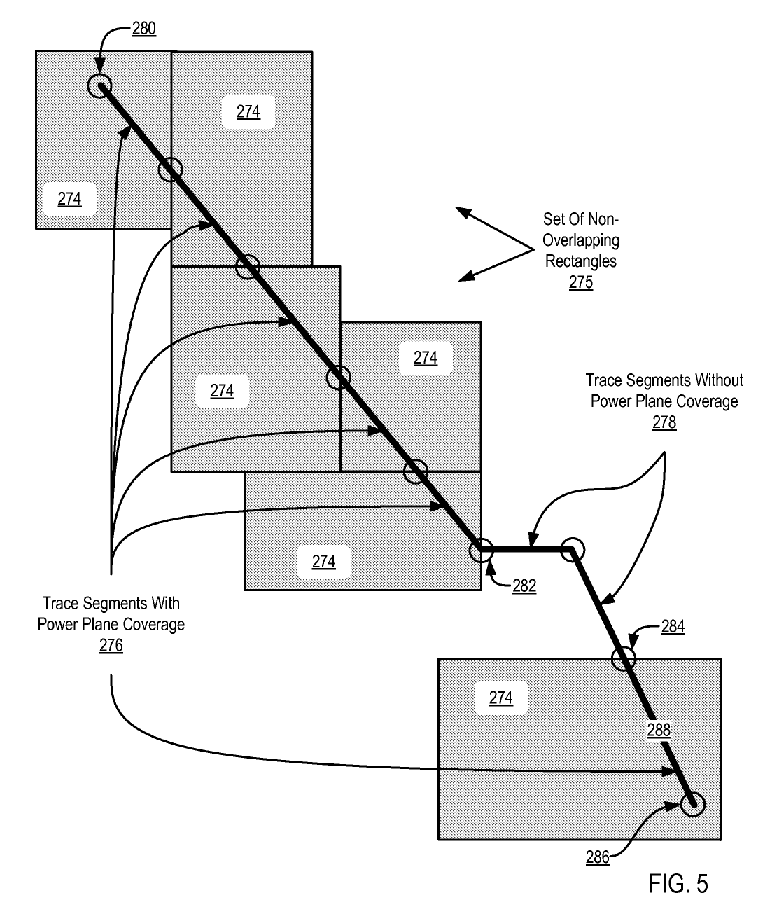

For further explanation, FIG. 5 illustrates a two-dimensional projection of a signal trace (288) from one side of a layer of dielectric substrate onto a power plane (274) from the other side of the same layer of dielectric substrate. FIG. 5 depicts a geometric description of the power plane (274), where the geometric description is created by an impedance discontinuity analysis module from a CAD, and the geometric description of the power plane is represented as a set of non-overlapping rectangles (275). The signal trace (288) is composed of a number of trace segments, identified with circles at their beginning coordinates and ending coordinates, where some of the trace segments have power plane coverage (276), and some of the trace segments have no power plane coverage (278).

Given a geometric representation of power plane coverage like the example illustrated in FIG. 5, an impedance discontinuity analysis module can identify an impedance discontinuity by identifying power plane coverage of the signal trace by identifying non-overlapping rectangles that cover trace segments of the signal trace, and, having identified the signal traces that are covered, therefore identifying the remaining trace segments of the signal trace as trace segments that have no power plane coverage. In this example, identifying the trace segments between reference points (280, 282) as covered trace segments that are covered by the power plane (274) can include effectively concatenating those trace segments into a portion of the signal trace that is covered and identified by the beginning coordinate at point (280) and the ending coordinate at point (282). Similarly, the covered trace segment between points (284, 286) can be identified by the coordinates of those points as a covered portion of the trace segment (288). Then, having identified the covered portions of the signal trace, any remaining trace segments not identified as covered trace segments are taken as trace segments having no power plane coverage. In this example, the two contiguous trace segments between reference points (282, 284) then are taken as a portion of the signal trace having no power plane coverage, identified by the coordinates of the reference points (282, 284), and further identified as an impedance discontinuity of the signal trace (288).

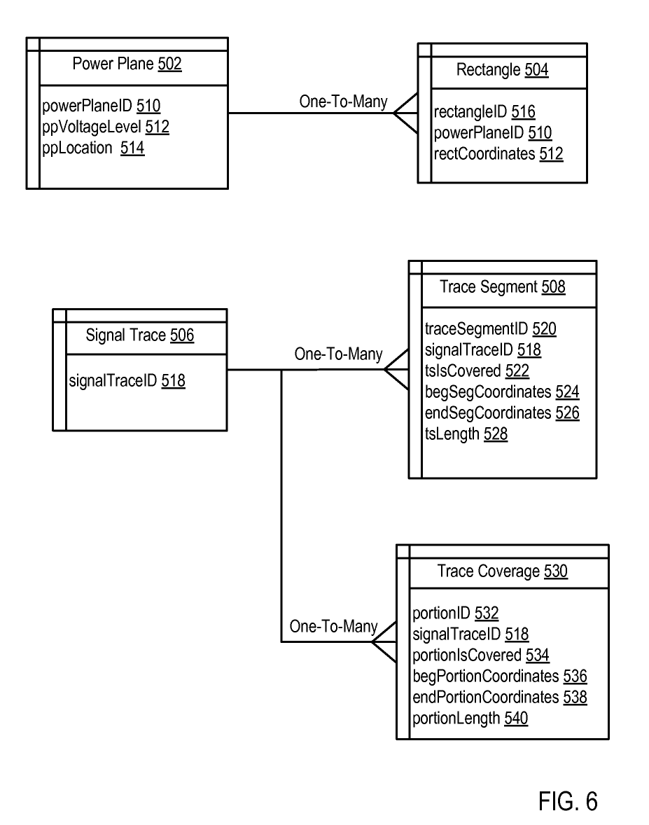

For further explanation, FIG. 6 sets forth an entity relationship diagram illustrating an exemplary data model useful for analyzing impedance discontinuities in a printed circuit board according to embodiments of the present invention. Entities pertinent to analyzing impedance discontinuities in a printed circuit board according to embodiments of the present invention in this example are represented by data structures. The entities so represented include power planes, non-overlapping rectangles, signal traces, trace segments, and covered portions of traces. For ease of explanation, the data structures of FIG. 6 are described as tables in a database, but this is not a limitation of the invention. Data structures for representing entities pertinent to analying impedance discontinuities in a printed circuit board according to embodiments of the present invention may be implemented as linked lists, hash tables, flat text files, database tables, and in other ways as will occur to those of skill in the art.

The example of FIG. 6 includes a power plane table (502), each record of which represents a power plane disposed on a layer of dielectric substrate of a printed circuit board. Each record of the power plane table includes a field named powerPlaneID (510) for storing a unique identification code for each power plane. Each record of the power plane table includes a field named ppVoltageLevel (512) for storing a characteristic voltage for each power plane. Each record of the power plane table includes a field named ppLocation (514) for storing each power plane's location within the printed circuit board, including, for example, which layer of the board the power plane is located on and the coordinates of the power plane within the layer.

The example of FIG. 6 includes a rectangle table (504), each record of which represents a non-overlapping rectangle that is part of a set of non-overlapping rectangles that together make up a geometric description of a power plane. The term ‘geometric description’ is used in this specification to mean a description that is effected by use of geometric elements and shapes such as points, lines, rectangles, and the like. Each record of the rectangle table includes a field named rectangleID (516) for storing a unique identification code for each non-overlapping rectangle. Each record of the power plane table includes a field named rectCoordinates (512) for storing the geometric coordinates of each rectangle on a layer of the printed circuit board. Each record of the rectangle table includes a field named powerPlaneID (510) for storing the identification code for a power plane. The powerPlaneID field acts as a foreign key that effects a one-to-many relationship between the power plane table (502) and the rectangle table (504). A set of rectangle records in the rectangle table having the same value in their powerPlaneID fields is a set of rectangle records representing the set of non-overlapping rectangles that together make up a geometric description of the power plane identified by the value in their powerPlaneID fields.

The example of FIG. 6 includes a signal trace table (506), each record of which represents a signal trace disposed on a layer of dielectric substrate of a printed circuit board. Each record of the signal trace table includes a field named signalTraceID (518) for storing a unique identification code for each signal trace. The signalTraceID field functions as a foreign key that implements a one-to-many relationship with a trace segment table (508) and a trace coverage table (530).

The example of FIG. 6 includes a trace segment table (508), each record of which represents a segment of a signal trace disposed on a layer of dielectric substrate of a printed circuit board. Each record of the trace segment table includes a field named traceSegmentID (520) for storing a unique identification code for each signal trace. Each record of the trace segment table includes a field named tsIsCovered (522) for storing a Boolean indication whether each trace segment is covered by a power plane. Each record of the trace segment table includes fields named begSegCoordinates (524) and endSegCoordinates (526) for storing the beginning geometric coordinates and the ending geometric coordinates of each trace segment. Each record of the trace segment table includes a field named tsLength (528) for storing the length of each trace segment.

The example of FIG. 6 includes a trace coverage table (530), each record of which represents a portion of a signal trace disposed on a layer of dielectric substrate of a printed circuit board, where each such portion is characterized as either covered or not covered by a power plane. Each record of the trace coverage table includes a field named portionID (532) for storing a unique identification code for each signal trace portion. Each record of the trace coverage table includes a field named portionIsCovered (534) for storing a Boolean indication whether each trace portion is covered by a power plane. Each record of the trace coverage table includes fields named begPortionCoordinates (536) and endPortionCoordinates (538) for storing the beginning geometric coordinates and the ending geometric coordinates of each trace portion. Each record of the trace coverage table includes a field named portionLength (540) for storing the length of each trace segment.

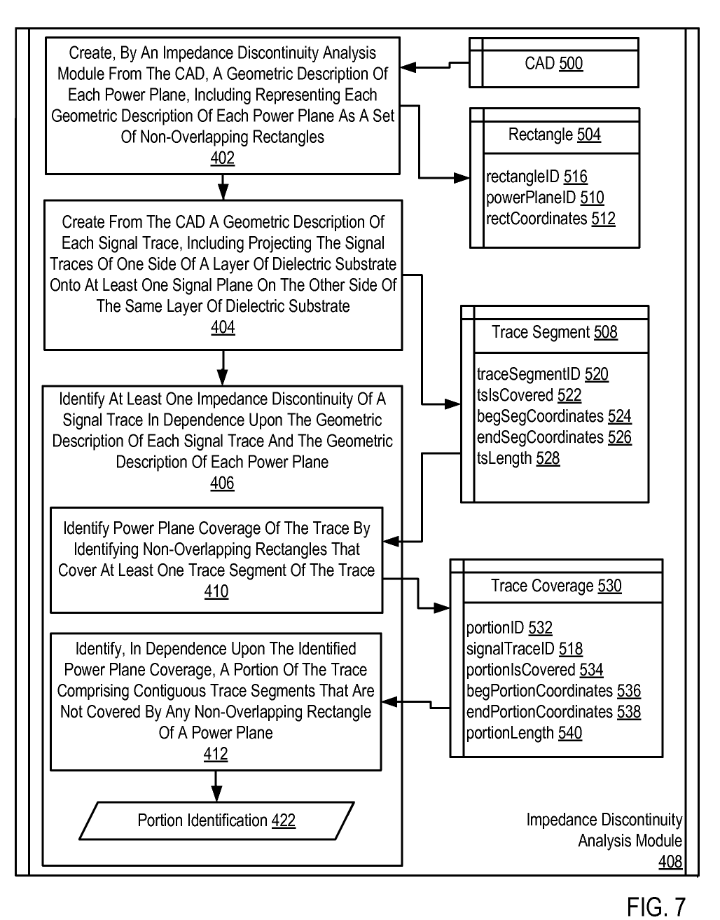

For further explanation, FIG. 7 sets forth a flow chart illustrating an exemplary method for analyzing impedance discontinuities in a printed circuit board according to embodiments of the present invention. The method of FIG. 7 is a computer-implemented method of analyzing impedance discontinuities in a printed circuit board that is made up of layers of dielectric substrate having signal traces and power planes disposed upon the layers of dielectric substrate, where the signal traces are in turn composed of trace segments, and the printed circuit board is described by a computer-aided design or ‘CAD’ (500). The method of FIG. 7 includes creating (402), by an impedance discontinuity analysis module (408) from the CAD (500), a geometric description of each power plane, including representing each geometric description of each power plane as a set of non-overlapping rectangles. In this example, the non-overlapping rectangles are represented by records in a rectangle table (504). Creating (402) a geometric description of each power plane can be carried out by extracting the coordinates of each power plane from a CAD (500), overlaying each power plane with a number of non-overlapping rectangles, and representing each such non-overlapping rectangle in a record of a table such as the one illustrated at reference (504) and explained in detail above with reference to FIG. 6.

The method of FIG. 7 also includes creating (404), by the impedance discontinuity analysis module (408) from the CAD (500), a geometric description of each signal trace, including projecting the signal traces of one side of a layer of dielectric substrate onto at least one signal plane on the other side of the same layer of dielectric substrate. Creating (404) a geometric description of each signal trace may be carried out by extracting from the CAD the coordinates of each trace, taking straight segments of each trace as trace segments, and creating a trace segment record in a trace segment table (508) to represent each trace segment.

The method of FIG. 7 also includes identifying (406) by the impedance discontinuity analysis module (408) at least one impedance discontinuity of a signal trace in dependence upon the geometric description of each signal trace and the geometric description of each power plane. In the method of FIG. 7, identifying (406) at least one impedance discontinuity includes identifying (410) power plane coverage of the signal trace by identifying non-overlapping rectangles that cover at least one trace segment of the signal trace. Explained with reference to the data structures of FIG. 6, identifying (410) power plane coverage of the signal trace by identifying non-overlapping rectangles that cover at least one trace segment of the signal trace may be carried out by scanning through rectangle table (504) and trace segment table (508), initially setting all values of tsIsCovered (522) to FALSE, comparing coordinates of non-overlapping rectangles and trace segments to identify all trace segments that are covered by any non-overlapping rectangle of a power plane, and marking covered trace segments by setting their tsIsCovered (522) values to TRUE. Now all the trace segment records whose tsIsCovered fields (522) are set to TRUE represent trace segments that are covered by a power plane. In this example, the traceSegmentID (520) fields are loaded with sequential, ordinal values, so that contiguous trace segments are identified by sequentially ordered, sorted or indexed, trace segment records having the same value of signalTraceID (518), that is, belonging to the same signal trace. Contiguous trace segments of a signal trace that are covered by a power plane, that is, their tsIsCovered values are set to TRUE, may be concatenated into a trace coverage record (530) with its portionIsCovered field (534) set to TRUE, so that a trace coverage record (530) represents a sequence of contiguous, covered trace segments. In the example of FIG. 5, the trace segments between reference points (280, 282) may all be concatenated into a single trace coverage record (530) that represents power plane coverage of the portion of signal trace (288) between reference points (280, 282).

In the method of FIG. 7, identifying (406) at least one impedance discontinuity includes identifying (412), in dependence upon the identified power plane coverage, a portion of the signal trace comprising contiguous trace segments that are not covered by any non-overlapping rectangle of a power plane. Impedence discontinuities are characterized by the portion of a signal trace that is not covered by a power plane. Now the power plane coverage, the portion of a signal trace that is covered, may be used to infer the portion of the signal trace that is not covered. Having set the values of the tsIsCovered fields (522) to TRUE for all trace segments that are covered by a power plane, now all the trace segment records whose tsIsCovered fields (522) are still set to FALSE represent trace segments that are not covered by a power plane—therefore presenting impedance discontinuities. Contiguous trace segments of a signal trace that are not covered by a power plane, that is, their tsIsCovered values are set to FALSE, may be concatenated into a trace coverage record (530) with its portionIsCovered field (534) set to FALSE, so such a trace coverage record (530) built from such trace segment records represents a sequence of contiguous trace segments of a signal trace that are not covered by a power plane—and which therefore represent an impedance discontinuity of that signal trace. In the example of FIG. 5, the trace segments between reference points (282, 284) may be concatenated into a single trace coverage record (530) that represents a lack of power plane coverage for the portion of signal trace (288) between reference points (282, 284). Such a trace coverage record identifies an impedance discontinuity of signal trace (288) between the coordinates of the reference points (282, 284).

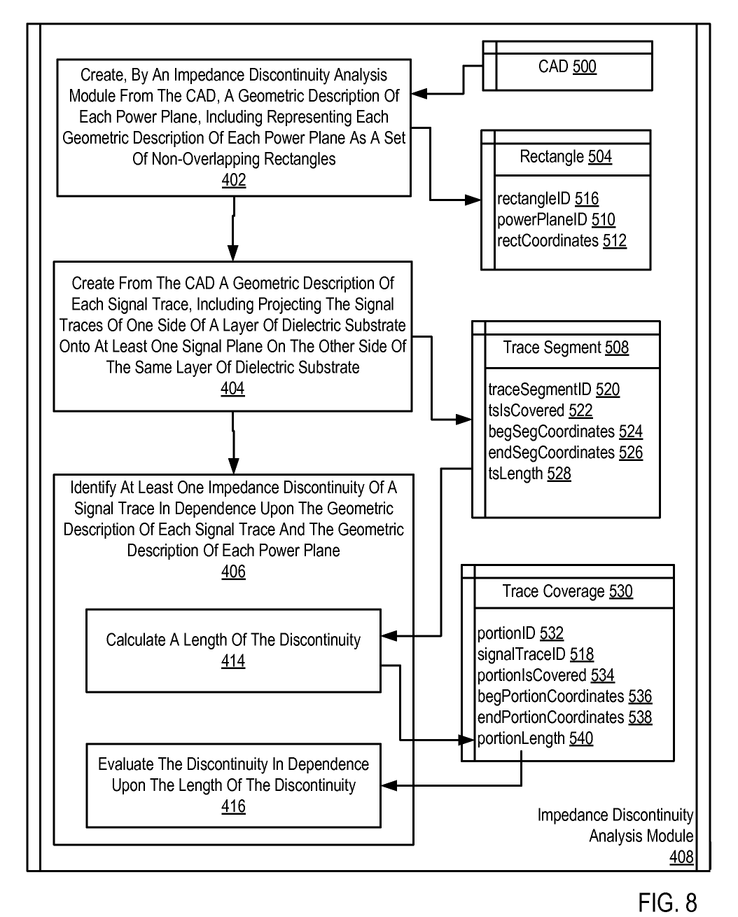

For further explanation, FIG. 8 sets forth a flow chart illustrating a further exemplary method for analyzing impedance discontinuities in a printed circuit board according to embodiments of the present invention where identifying (406) at least one impedance discontinuity includes calculating (414) a length of the discontinuity and evaluating (416) the impedance discontinuity in dependence upon the length of the discontinuity. An impedance discontinuity in this example is represented by a record in the trace coverage table (530) with its portionIsCovered field set to FALSE. Lengths (528) of individual trace segments may be calculated from the trace segment beginning coordinates and ending coordinates (524, 526) and summed into portionLength (540) when the trace segment records are concatenated into the trace coverage records. Or the length of an impedance discontinuity may be calculated from the beginning and ending coordinates (536, 538) of the impedance discontinuity itself, represented by a trace coverage record with its portionIsCovered (534) value set to FALSE.

Evaluating (416) the impedance discontinuity in dependence upon the length of the discontinuity may be carried out by taking the evaluation of the impedance discontinuity as proportional to the length of the discontinuity, so that longer discontinuities are given larger evaluations than shorter discontinuities. Alternatively, the width of the discontinuity may be included in the evaluation, taking the evaluation of the impedance discontinuity as proportional to area, so that impedance discontinuities with larger areas are given larger evaluations than impedance discontinuities with smaller areas. Alternatively, the length of the signal trace of the impedance discontinuity may be included in the evaluation, taking the evaluation of the impedance discontuity as related to the length of the discontinuity in proportion to the overall length of the signal trace, so that impedance discontinuities that represent a larger proportion of a signal trace are given larger evaluations than impedance discontinuities that represent a smaller proportion of a signal trace.

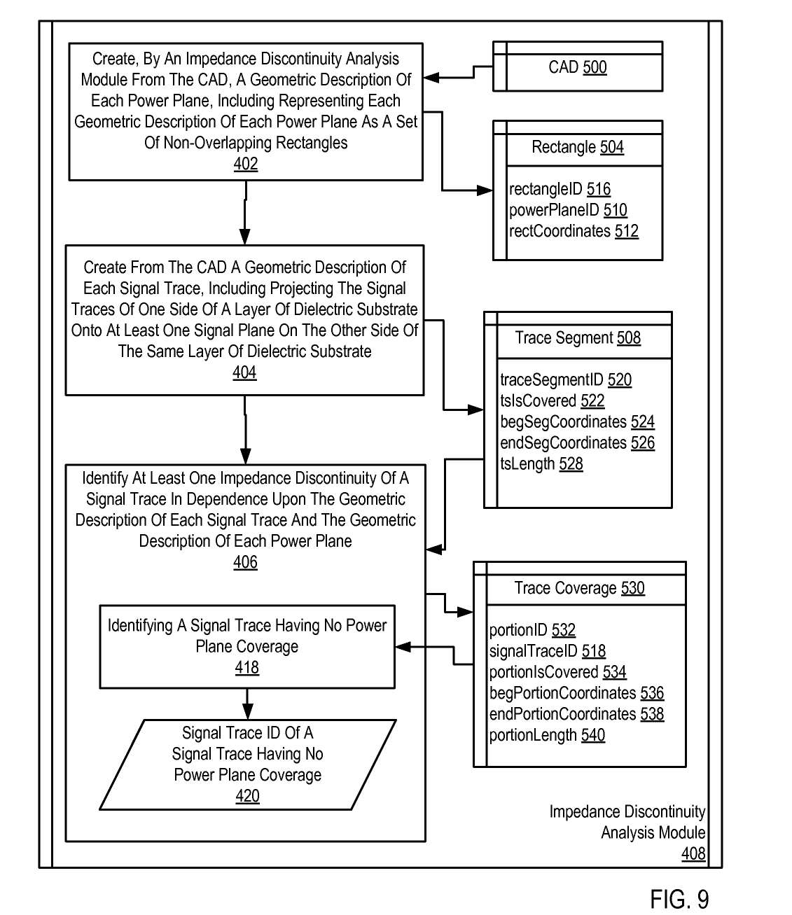

For further explanation, FIG. 9 sets forth a flow chart illustrating a further exemplary method for analyzing impedance discontinuities in a printed circuit board according to embodiments of the present invention where identifying (406) at least one impedance discontinuity includes identifying (418) a signal trace (420) having no power plane coverage. That is, the signal trace is composed of one or more trace segments none of which are covered by any power plane. A signal trace having no power plane coverage is indicated in the example trace coverage table (530) by the presence of only a single trace coverage record for a signal trace. That is, there is only one trace coverage record in the trace coverage file having a particular value of signalTraceID (518), and that record's portionIsCovered field (534) is set to FALSE. Such a trace coverage record represents a signal trace having no power plane coverage because that fact that there is only one trace coverage record with a particular value of signalTraceID means that all the trace segments of that entire signal trace were concatenated into a single trace coverage record, and portionIsCovered=FALSE means that this single trace coverage record represents an impedance discontinuity—so that the entire signal trace represents an impedance discontinuity. This fact pattern is exemplified on FIG. 4 by signal trace (264) which is composed of three trace segments, none of which is covered by any power plane. When the uncovered segments of such a signal trace are concatenated into an uncovered portion of the signal trace, that ‘portion’ is the entire signal trace.

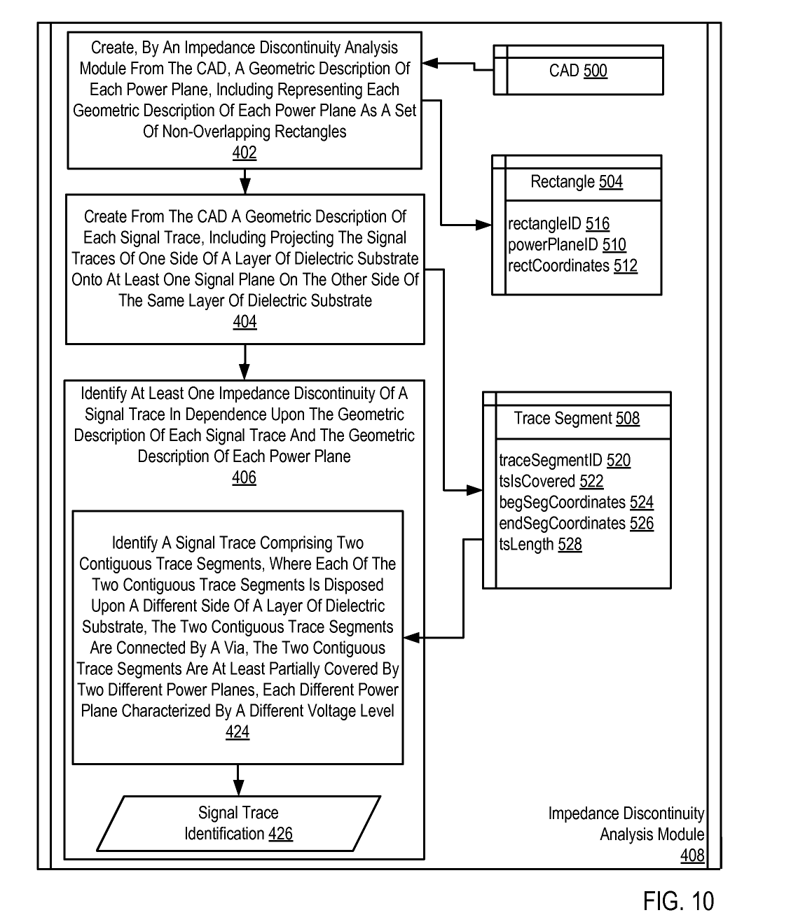

For further explanation, FIG. 10 sets forth a flow chart illustrating a further exemplary method for analyzing impedance discontinuities in a printed circuit board according to embodiments of the present invention where identifying (406) at least one impedance discontinuity includes identifying (424) a signal trace (426) that includes two contiguous trace segments, where each of the two contiguous trace segments is disposed upon a different side of one or more layers of dielectric substrate, the two contiguous trace segments are connected by a via, and the two contiguous trace segments are at least partially covered by two different power planes, with each different power plane characterized by a different voltage level. Physical defects that represent or cause impedance discontinuities include a signal trace covered by a power plane of a voltage on one layer of the printed circuit board where the signal trace changes levels through a via to be covered in another layer by a power plane of another voltage. In the example of FIG. 3, if power plane (202) is a three-volt power plane and power plane (214) is a five-volt power plane, then signal trace (218) presents an impedance discontinuity where the signal trace (218) passes through the via (220) from one side to the other side of the dielectric substrate layer (208).

Exemplary embodiments of the present invention are described largely in the context of a fully functional computer system for analyzing impedance discontinuities in a printed circuit board. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of analyzing impedance discontinuities in a printed circuit board, the printed circuit board comprising layers of dielectric substrate having signal traces and power planes disposed upon the layers of dielectric substrate, the signal traces comprising trace segments, the printed circuit board described by a computer-aided design (‘CAD’), the method comprising:
creating, by an impedance discontinuity analysis module from the CAD, a geometric description of each power plane, including representing each geometric description of each power plane as a set of non-overlapping rectangles; and
creating, by the impedance discontinuity analysis module from the CAD, a geometric description of each signal trace, including projecting the signal traces of one side of a layer of dielectric substrate onto at least one signal plane on the other side of the same layer of dielectric substrate; and
identifying by the impedance discontinuity analysis module at least one impedance discontinuity of a signal trace in dependence upon the geometric description of each signal trace and the geometric description of each power plane.

2. The method of claim 1 wherein the printed circuit board comprises a first-level carrier for an integrated circuit.

3. The method of claim 1 wherein identifying at least one impedance discontinuity further comprises identifying a portion of the signal trace that is not covered by any power plane.

4. The method of claim 1 wherein identifying at least one impedance discontinuity further comprises identifying a portion of the signal trace that is not covered by any non-overlapping rectangle of a power plane.

5. The method of claim 1 wherein identifying at least one impedance discontinuity further comprises:
identifying power plane coverage of the signal trace by identifying non-overlapping rectangles that cover at least one trace segment of the signal trace; and
identifying, in dependence upon the identified power plane coverage, a portion of the signal trace comprising contiguous trace segments that are not covered by any non-overlapping rectangle of a power plane.

6. The method of claim 1 wherein identifying at least one impedance discontinuity further comprises calculating a length of the discontinuity and evaluating the impedance discontinuity in dependence upon the length of the discontinuity.

7. The method of claim 1 wherein identifying at least one impedance discontinuity further comprises identifying a signal trace having no power plane coverage.

8. The method of claim 1 wherein identifying at least one impedance discontinuity further comprises identifying a signal trace comprising two contiguous trace segments, wherein each of the two contiguous trace segments is disposed upon a different side of one or more layers of dielectric substrate, the two contiguous trace segments connected by a via, the two contiguous trace segments at least partially covered by two different power planes, each different power plane characterized by a different voltage level.

9. Apparatus for analyzing impedance discontinuities in a printed circuit board, the printed circuit board comprising layers of dielectric substrate having signal traces and power planes disposed upon the layers of dielectric substrate, the signal traces comprising trace segments, the printed circuit board described by a computer-aided design (‘CAD’), the apparatus comprising a computer processor and a computer memory operatively coupled to the computer processor, the computer memory having disposed within it computer program instructions capable of:
creating, by an impedance discontinuity analysis module from the CAD, a geometric description of each power plane, including representing each geometric description of each power plane as a set of non-overlapping rectangles; and
creating, by the impedance discontinuity analysis module from the CAD, a geometric description of each signal trace, including projecting the signal traces of one side of a layer of dielectric substrate onto at least one signal plane on the other side of the same layer of dielectric substrate; and
identifying by the impedance discontinuity analysis module at least one impedance discontinuity of a signal trace in dependence upon the geometric description of each signal trace and the geometric description of each power plane.

10. The apparatus of claim 9 wherein identifying at least one impedance discontinuity further comprises:
identifying power plane coverage of the signal trace by identifying non-overlapping rectangles that cover at least one trace segment of the signal trace; and
identifying, in dependence upon the identified power plane coverage, a portion of the signal trace comprising contiguous trace segments that are not covered by any non-overlapping rectangle of a power plane.

11. The apparatus of claim 9 wherein identifying at least one impedance discontinuity further comprises calculating a length of the discontinuity and evaluating the impedance discontinuity in dependence upon the length of the discontinuity.

12. The apparatus of claim 9 wherein identifying at least one impedance discontinuity further comprises identifying a signal trace having no power plane coverage.

13. The apparatus of claim 9 wherein identifying at least one impedance discontinuity further comprises identifying a signal trace comprising two contiguous trace segments, wherein each of the two contiguous trace segments is disposed upon a different side of one or more layers of dielectric substrate, the two contiguous trace segments connected by a via, the two contiguous trace segments at least partially covered by two different power planes, each different power plane characterized by a different voltage level.

14. A computer program product for analyzing impedance discontinuities in a printed circuit board, the printed circuit board comprising layers of dielectric substrate having signal traces and power planes disposed upon the layers of dielectric substrate, the signal traces comprising trace segments, the printed circuit board described by a computer-aided design (‘CAD’), the computer program product disposed upon a signal bearing medium, the computer program product comprising computer program instructions capable of:
creating, by an impedance discontinuity analysis module from the CAD, a geometric description of each power plane, including representing each geometric description of each power plane as a set of non-overlapping rectangles; and
creating, by the impedance discontinuity analysis module from the CAD, a geometric description of each signal trace, including projecting the signal traces of one side of a layer of dielectric substrate onto at least one signal plane on the other side of the same layer of dielectric substrate; and
identifying by the impedance discontinuity analysis module at least one impedance discontinuity of a signal trace in dependence upon the geometric description of each signal trace and the geometric description of each power plane.

15. The computer program product of claim 14 wherein the signal bearing medium comprises a recordable medium.

16. The computer program product of claim 14 wherein the signal bearing medium comprises a transmission medium.

17. The computer program product of claim 14 wherein identifying at least one impedance discontinuity further comprises:
identifying power plane coverage of the signal trace by identifying non-overlapping rectangles that cover at least one trace segment of the signal trace; and
identifying, in dependence upon the identified power plane coverage, a portion of the signal trace comprising contiguous trace segments that are not covered by any non-overlapping rectangle of a power plane.

18. The computer program product of claim 14 wherein identifying at least one impedance discontinuity further comprises calculating a length of the discontinuity and evaluating the impedance discontinuity in dependence upon the length of the discontinuity.

19. The computer program product of claim 14 wherein identifying at least one impedance discontinuity further comprises identifying a signal trace having no power plane coverage.

20. The computer program product of claim 14 wherein identifying at least one impedance discontinuity further comprises identifying a signal trace comprising two contiguous trace segments, wherein each of the two contiguous trace segments is disposed upon a different side of one or more layers of dielectric substrate, the two contiguous trace segments connected by a via, the two contiguous trace segments at least partially covered by two different power planes, each different power plane characterized by a different voltage level.
